(19) United States
(12) Patent Application Publication
(10) Pub. No.: US 2016/0040624 A1
(43) Pub. Date: Feb. 11, 2016

(54) NACELLE JET PIPE DEVICES FOR REGULATING PRESSURE

(71) Applicant: AIRCELLE, GONFREVILLE L'ORCHER (FR)

(72) Inventors: Xavier Bouteiller, Deville les Rouen (FR); Patrick Gonidec, Bretx (FR); Laurent Albert Blin, Sainte Adresse (FR)

(73) Assignee: AIRCELLE, GONFREVILLE L'ORCHER (FR)

(21) Appl. No.: 14/797,587

(22) Filed: Jul. 13, 2015

Related U.S. Application Data
(63) Continuation of application No. PCT/FR2014/050087, filed on Jan. 16, 2014.

(30) Foreign Application Priority Data
Jan. 16, 2013 (FR) 13/50375

(51) Int. Cl. F02K 1/06; F01D 25/24

(52) U.S. Cl. CPC F02K 1/06; F01D 25/24; F05D 2220/323

(57) ABSTRACT

A nacelle jet pipe is equipped with a device for regulating the pressure of a flow of air leaving the jet pipe. The device includes an annular element surrounding the downstream end of the jet pipe, and an adjuster to adjust the position of part of the annular element in relation to the downstream end of the jet pipe. In particular, the annular element forms, with the downstream end of the jet pipe, a constricted zone the widest part of which is situated upstream of the narrowest part and the profile of which can be varied according to the position of the annular element.

### CROSS-REFERENCE TO RELATED APPLICATIONS

This application is a continuation of International Application No. PCT/FR2014/050087, filed on Jan. 16, 2014, which claims the benefit of FR 13/50375, filed on Jan. 16, 2013. The disclosures of the above applications are incorporated herein by reference.

### FIELD

The present disclosure relates to the field of nozzles of nacelles for turbojet engines and more particularly nozzles adapted to the operation of high-bypass ratio engines.

### BACKGROUND

The statements in this section merely provide background information related to the present disclosure and may not constitute prior art.

An aircraft is propelled by one or several propulsion unit(s) each comprising a turbojet engine housed in a tubular nacelle. Each propulsion unit is fastened to the aircraft via a mast generally located under a wing or at the fuselage.

In general, a nozzle presents a structure comprising an upstream section for air inlet, upstream of the engine, a mid-section intended to surround a fan of the turbojet engine, and a downstream section intended to surround the combustion chamber of the turbojet engine and most often accommodating thrust reversal means.

By upstream, it is meant what comes before the considered point or element, in the direction of the flow of the air in a turbojet engine, and by downstream, it is meant what comes after the considered point or element, in the direction of the flow of the air in a turbojet engine.

Currently, adapting the behavior of the nozzles at high bypass ratios in order to avoid the pumping risks, that is to say the risks of oscillations of velocity and pressure in the air flow which are observed at some speeds in the turbomachines resulting in a leveling of the performances of the compressor and which may result in the rupture of blades of the compressor, is achieved by increasing the outlet section in the operation ranges of the fan where the flow rate is low and the compression ratio is high.

The drawback of this technology called VAFN (Variable-Area Fan Nozzle, that is to say that the surface area of the outlet section of a nacelle is varied in order to regulate the flow of air at said section) technology lies in that it requires the implementation of heavy and complex structures. The VAFN technology is also less effective in the case where the compression ratio is low, lower than 1.3, while the bypass ratio, that is to say the ratio between the cold air stream mass and the hot air stream mass of a bypass turbojet engine is high, in the specific case of a bypass turbojet engine.

There is known the document EP 0 578 951 A1, which discloses a thrust nozzle for an engine block comprising a fixed nozzle and a diverging fixed nozzle extension, which may be displaced axially for an enlargement on the outlet side of the flow channel of hot gases which, in the deployed position, is essentially fitted to an identical shape, at the diverging outlet end of the outer wall of the fixed nozzle. In the retracted position, the fixed nozzle extension forms, together with the fixed nozzle, an air outlet channel, controllable and surrounding in an annular shape the wall end of the thrust nozzle. In the lower range of the flight speeds where the thrust nozzle extension is not necessary for the enlargement of the outer perimeter of the flow channel of hot gases, there is produced a secondary air flow which is uniform over the whole outer periphery of the fixed nozzle end of the engine block.

In this document of the prior art, the extension of the fixed nozzle is shaped so that, in the deployed position, its upstream end is essentially fitted to an identical shape at the downstream end of the fixed nozzle of the engine block, and in the retracted position, it forms an air passage channel with the fixed nozzle. In addition, the nozzle extension can take only but two positions, the retracted position and the deployed position. Finally, in the retracted position, the fixed nozzle extension cannot influence the air stream with the fixed nozzle.

A nozzle technology developed in the vertical-takeoff aircrafts with swivelling nozzles, has also been proposed with subsonic jet pumps ejecting a stream through a fixed annular element. This technology is essentially intended to enable directing the thrust toward the ground.

### SUMMARY

The present disclosure provides a nozzle comprising a device for regulating the outlet pressure of an air flow remarkable in that said device comprises an annular element surrounding the downstream end of the nozzle and at a distance therefrom, and means for adjusting the position of at least one portion of the annular element with respect to the downstream end of the nozzle, and in that the annular element forms, together with the downstream end of the nozzle, a pinch area the most flared portion of which is located upstream of its most narrowed portion and the profile of which varies according to the position of the annular element. As a result, the outlet static pressure of the nozzle is adjusted in order to reduce the possibility of pumping the engine.

The annular element and the nozzle define together a channel surrounding, in an annular shape, the downstream end of the nozzle. Thus, an air flow may exist between the annular element and the downstream end of the nozzle.

The annular element may be deformable so that only one portion of the annular portion is position-adjustable.

Advantageously, the adjustment of the position of at least one portion of the annular element allows modulating the flow of air between the annular element and the nozzle, that is to say that it allows modulating its velocity and its pressure at the outlet of the annular element.

Advantageously, the air that circulates between the annular element and the nozzle allows wrapping the air flow at the outlet of the nozzle and therefore having an influence on the pressure of the flow of the air at the outlet of the nozzle.

Advantageously, the pinch area allows accelerating the flow of the air that passes between the annular element and the nozzle, and consequently, the pressure at the end of the pinch area is lower than the ambient pressure. For this reason, it is called a pinch effect (or jet pump effect). Thus, the air that circulates in the nozzle flows in a depression area in the vicinity of the downstream end of the nozzle. Thus, the pressure at the outlet of the nozzle, and therefore the compression ratio, are decreased.

Advantageously, the higher the pinch effect, the lower is the pressure at the outlet of the pinch area, and hence, the lower are the pressure at the outlet of the nozzle and the compression ratio.

Advantageously, the flow of the air that circulates between the annular element and the nozzle preserves as much as possible the structure of the stream lines, in particular by keeping the stream lines as close as possible to those existing without the annular element.

Advantageously, when the turbojet engine is in cruise operation during which it is not necessary to control the flow of air at the outlet of the nozzle, the position of the annular element may be adjusted so that it forms, together with the nozzle, a substantially zero (or uniform) pinch area. Thus, in this configuration, the air that passes between the annular element and the nozzle is not substantially accelerated and therefore has little if any effect on the pressure of the air flow at the outlet of the nozzle.

Advantageously, even when the turbojet engine is in cruise operation, the annular element remains inclined with respect to the downstream end of the nozzle in pinch configuration in such a manner that the pinch area generates a thrust, called a shape thrust, that is to say a thrust that is made possible only by the shape of a static part (in the same way as a ramjet engine uses a particular shape of a static inlet handle for compressing the air penetrating therein), thereby compensating the frictional drag that is added due to the presence of the annular element.

According to one form of the present disclosure, the inner wall of the annular element forms, together with the nozzle, converging and diverging areas facing the air flow direction.

Thus, the converging area located upstream of the annular element is used to obtain the pinch effect or jet pump effect described above, and the diverging area downstream of the annular element advantageously allows generating an increase of the thrust force of the assembly formed by the nozzle and the turbojet engine.

In another form, the outer wall of the annular element is substantially planar, and the upstream and downstream edges of the annular element are rounded.

According to another from of the present disclosure, and in the case where the annular element presents this converging—diverging shape, the borderline between the converging and diverging areas of the annular element may be located in the plane in which the downstream end of the nozzle lies or in at least one of the positions of the annular element.

Thus, the flow of the air that circulates between the annular element and the downstream end of the nozzle is accelerated until the plane in which the downstream end of the nozzle lies. From the plane in which the downstream end of the nozzle lies, the flow of the air at the outlet of the annular element comes into contact with the flow of the air at the outlet of the nozzle with a pressure that is lower than the ambient pressure thereby decreasing the pressure of the flow of the air at the outlet of the nozzle.

According to another feature of the present disclosure, the annular element is constituted by a plurality of rigid flaps or sectors.

By rigid flaps, it is meant flaps that are not substantially deformable under the effect of the flow of the air that circulates between the annular element and the nozzle and under the effect of the air flow at the outlet of the nozzle.

In one form, the rigid flaps are evenly distributed along the perimeter of the downstream end of the nozzle. The thus distributed rigid flaps enable a flow of the air between the annular element and the nozzle so that the air flow at the outlet of the nozzle is substantially wrapped by the air flow at the outlet of the channel formed by the annular element and the downstream end of the nozzle, and therefore the control of the pressure of the air flow at the outlet of the nozzle is easier.

According to another feature of the present disclosure, the annular element constituted by a plurality of rigid flaps is rotatably movable about axes tangent to the nozzle and substantially orthogonal to the axis of the nozzle.

Advantageously, a slight increase of the inclination of the rigid flaps of the annular element relative to the nozzle in the order of a few degrees (for example 2 or 3 degrees) allows a displacement of the upstream end of the annular element in the centimeter order at the same time as a displacement of the downstream end of the annular element in such a manner that a pinch effect is obtained, varying according to the inclination of the rigid flaps of the annular element.

The rigid flaps are mounted movable in rotation about an axis proper to each one, each axis being carried by a support secured on the downstream end of the nozzle.

According to another feature of the present disclosure, the annular element is movable in translation, whether it is constituted by a plurality of rigid flaps or by any other manner.

Advantageously, the translational mobility of the annular element constitutes a simple way for adjusting the pinch effect.

Advantageously, when the annular element is constituted by flaps, the rigid flaps may be movable both in translation and in rotation so as to obtain a larger pinch effect range and a finer adjustment of the pressure of the air flow at the outlet of the nozzle.

According to one form of the present disclosure, the annular element comprises inflatable boxes.

Advantageously, the inflatable boxes are deformable at least at their downstream end under the effect of pressure.

Thus, the air flow that passing in the channel formed by the annular element, constituted by the inflatable boxes and the nozzle may deform said boxes.

The inflatable boxes may be translatable and/or mounted movable in rotation about an axis proper to each one, each axis being carried by a support secured on the downstream end of the nozzle.

According to another feature of the present disclosure, the internal pressure of the inflatable boxes is regulated by means of a compressed air motor type device.

Advantageously, the compressed air motor type device allows regulating the internal pressure of the inflatable boxes depending on the desired pressure of the air flow at the outlet of the nozzle.

Advantageously, it is possible to combine the technology of inflatable boxes with that of rigid flaps in such a manner that the annular element is constituted by a plurality of flaps each presenting a rigid upstream area and a downstream area deformable under pressure and constituted by an inflatable box the internal pressure of which may be regulated.

According to another form of the present disclosure, the inlet section in the pinch area presents a surface area which is close to or larger than the outlet section of the nozzle.

Advantageously, in this configuration, the pinch effect is used to increase thrust during the takeoff of the aircraft and to improve the propulsive efficiency of the fan while maintaining a low bypass ratio adapted to the cruise operation.

When the turbojet engine is in cruise operation, the annular element is displaced in such a manner that the pinch effect is substantially zero.

According to another feature of the present disclosure, the nozzle comprises a device for injecting modular pressurized air located at the nozzle.

The device for injecting modular pressurized air injects air from upstream to downstream of the nozzle and is oriented so that the resulting air flow penetrates into the channel formed by the annular element and the nozzle.

In another form, the device for injecting modular pressurized air is located upstream of the annular element in proximity to the upstream end of the annular element or the leading edge of the annular element.

Advantageously, with such a device for injecting modular pressurized air, combined with the annular element, it is no longer necessary to change the position of the annular element (the annular element is fixed with respect to the nozzle) in order to control the pressure of the air flow at the outlet of the nozzle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1a is a perspective view of a nacelle equipped with a nozzle according to a first form of the present disclosure;

FIG. 1b is a schematic view of a nozzle according to the first form of the present disclosure;

FIG. 2a represents a perspective view of a nacelle equipped with a nozzle according to a second form of the present disclosure;

FIG. 2b is a schematic view of a nozzle according to the second form of the present disclosure;

FIG. 3 is a schematic view of a nozzle according to a third form of the present disclosure;

FIG. 4 is a schematic view of a nozzle according to a fourth form of the present disclosure; and

FIG. 5 is a sectional view of a nozzle according to a fifth form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

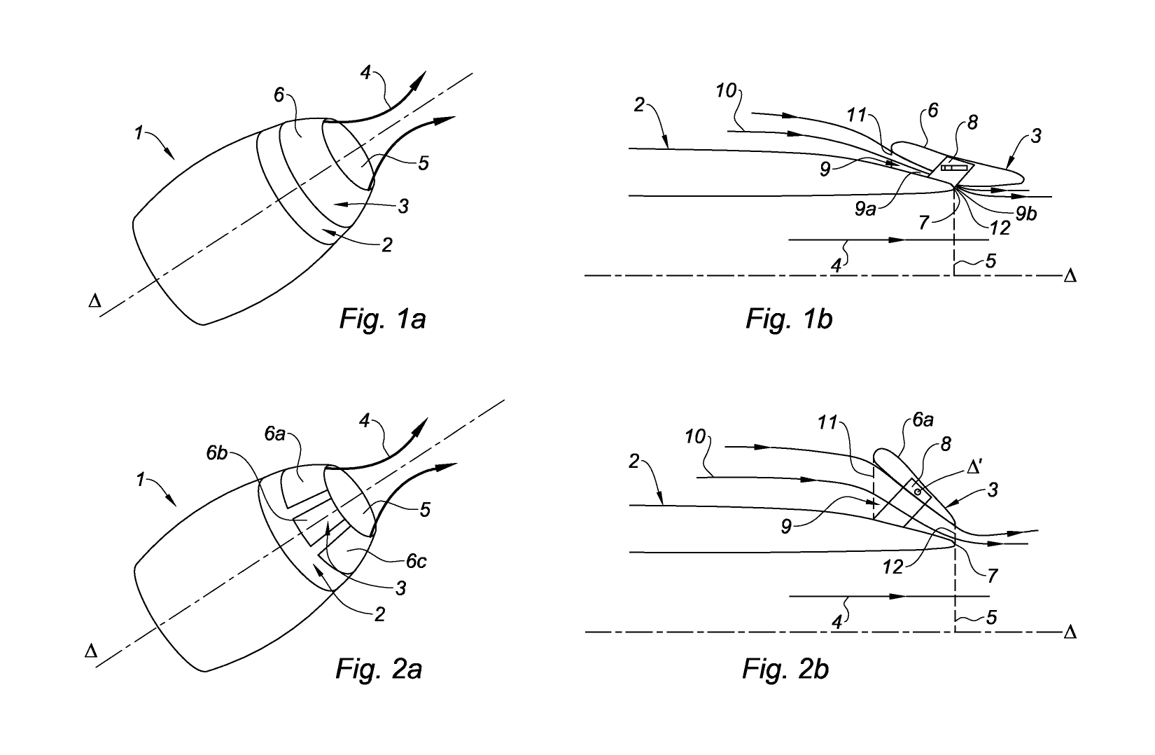

Referring to FIGS. 1a and 1b, a nacelle 1 is equipped with a nozzle 2 comprising a device 3 for regulating the pressure of an air flow 4 at the outlet 5 of the nozzle 2. The device 3 comprises an annular element 6 surrounding the downstream end 7 of the nozzle 2 and at a distance from said nozzle 2, and means 8 for adjusting the position of the annular element 6 by translation of the annular element 6 along an axis substantially parallel to the axis Δ of the nozzle 2. The annular element 6 is shaped in such a manner that it forms, together with the downstream end 7 of the nozzle 2, a converging 9a—diverging 9b area 9 facing an air flow 10 between the annular element 6 and the nozzle 2. The means 8 for adjusting the position of the annular element 6 by translation of the annular element 6 are shaped in such a manner that the adjustment of the position of the annular element 6 is performed in a continuous manner, in contrast with the discrete manner which is less flexible and does not enable such a fine adjustment. Nonetheless, it is possible to consider using adjustment means 8 such as to have a discretized adjustment of the position of the annular element 6.

When passing through the inlet section 11 in the converging 9a—diverging 9b area 9, the air flow 10 undergoes a pinch effect, that is to say that the air flow 10 is accelerated until reaching the outlet section 12 of the converging 9a—diverging 9b area 9. At the outlet section 12, the air flow 10 undergoes an expansion accentuated by the fact that the air flow 4 at the outlet 5 of the nozzle 2 <<sucks in>> the air flow 10 in the vicinity of the outlet section 12, thereby creating at the diverging portion of the area 9 a depression so that the pressure in this diverging portion is lower than the atmospheric pressure. Thus, the air flow 4 at the outlet 5 of the nozzle 2 is depressurized when passing through the outlet 5 of the nozzle 2 and penetrates the atmosphere more easily. The diverging portion of the area 9 allows obtaining an additional thrust force added to that already provided by the air flow 4. This configuration allows reducing the energy consumption by the turbojet engine, and limiting the pumping risks of the turbojet engine.

When the annular element 6 is translated along the axis A downstream of the nozzle 2, the inlet section 11 and the outlet section 12 are enlarged, thereby decreasing the pinch effect caused by the converging portion of the converging 9a—diverging 9b area. When the annular element 6 is translated along the axis Δ upstream of the nozzle 2, the inlet section 11 and the outlet section 12 are reduced, thereby increasing the pinch effect caused by the converging portion of the converging 9a—diverging 9b area 9.

Referring to FIGS. 2a and 2b, a nacelle 1 is equipped with a nozzle 2 comprising a device 3 for regulating the pressure of the air flow 4 at the outlet 5 of the nozzle 2. The device 3 comprises a plurality of rigid flaps 6a, 6b, 6c which form the annular element 6 surrounding the downstream end 7 of the nozzle 2 in an evenly distributed manner and at a distance from said nozzle 2, and means 8 for adjusting the position by rotation of each of the rigid flaps about an axis Δ′ tangent to the downstream end 7 of the nozzle 2 and orthogonal to the axis Δ of the nozzle 2. The rigid flaps 6a, 6b, 6c are shaped in such a manner that each of them forms, together with the downstream end 7 of the nozzle 2, a converging 9a area 9 facing an air flow 10 between the rigid flap 6a, 6b, 6c and the nozzle 2. The means 8 for adjusting the position of the rigid flaps 6a, 6b, 6c by rotation of the rigid flaps 6a, 6b, 6c are shaped in such a manner that the adjustment of the position of the rigid flaps 6a, 6b, 6c is performed in a continuous manner, in contrast with the discrete manner which is less flexible and does not enable such a fine adjustment. Nonetheless, it is possible to consider using adjustment means 8 such as to have a discretized adjustment of the position of the flaps 6a, 6b, 6c.

When passing through the inlet section 11 in the converging 9a area 9, the air flow 10 undergoes a pinch effect. At the outlet section 12, the air flow 10 undergoes an expansion accentuated by the fact that the air flow 4 at the outlet 5 of the nozzle 2—sucks in—the air flow 10 in the vicinity of the outlet section 12, thereby creating a depression so that the downstream pressure in the vicinity of the outlet section 12 is lower than the atmospheric pressure. Thus, the air flow 4 at the outlet 5 of the nozzle 2 is depressurized when passing through the outlet 5 of the nozzle 2 and thereby penetrates the atmosphere more easily. This configuration allows reducing the energy consumption by the turbojet engine, and limiting the pumping risks of the turbojet engine.

When the rigid flaps 6a, 6b, 6c pivot, each about its axis of rotation tangent to the downstream end 7 of the nozzle 2, the ratio of the inlet section 11 to the outlet section 12 of each flap or pinch ratio varies, thereby varying the pinch effect caused by the converging 9a area 9 of each flap. The greater the pinch ratio, the higher is the pinch effect in the converging 9a area 9.

In one form, the rigid flaps 6a, 6b, 6c pivot simultaneously, and in such a manner that the inclination of the rigid flaps 6a, 6b, 6c is the same for all the rigid flaps 6a, 6b, 6c with respect to the nozzle.

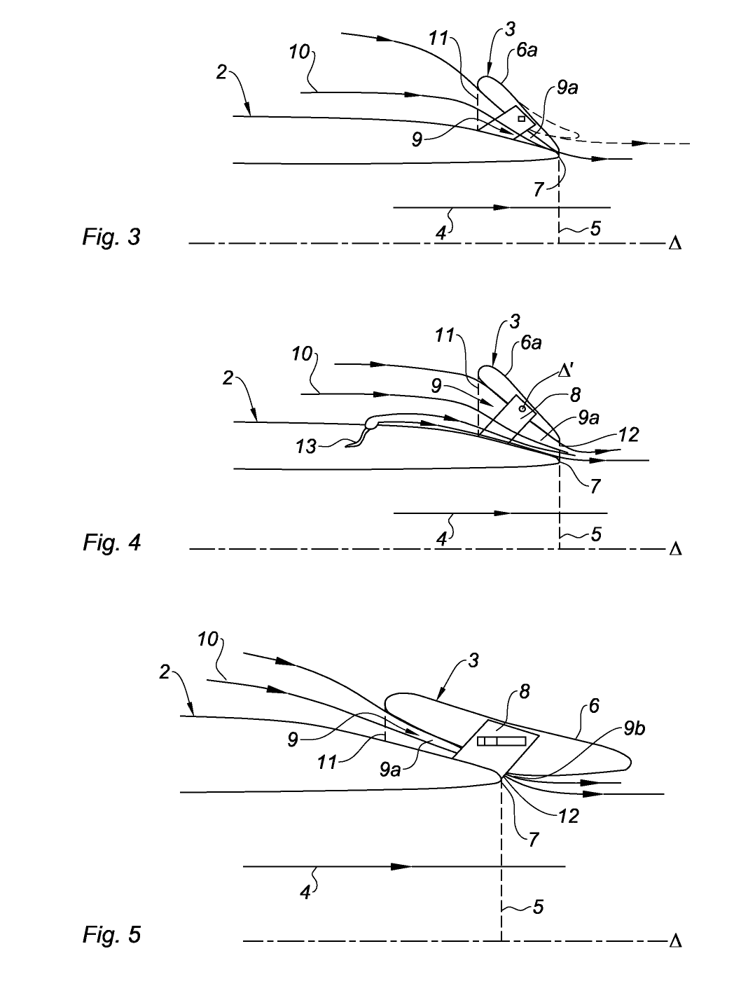

Referring to FIG. 3, a nozzle 2 comprises a device 3 for regulating the pressure of an air flow 4 at the outlet 5 of the nozzle 2. The device 3 comprises a plurality of inflatable boxes 6a, 6b, 6c which form an annular element 6 surrounding the downstream end 7 of the nozzle 2 in an evenly distributed manner and at a distance from said nozzle 2. The inflatable boxes 6a, 6b, 6c are shaped so that a manner that their upstream end is secured with no degree of freedom on the nozzle by a securing means 8a, so that they are deformable under the effect of the air flow 10, and so that each one forms, together with the downstream end 7 of the nozzle 2, a converging 9a area 9 facing the air flow 10 between the inflatable box 6a, 6b, 6c and the nozzle 2. Hence, the air flow 10 acts as a means 8 for adjusting the position of the inflatable boxes.

When passing through the inlet section 11 in the converging 9a area 9, the air flow 10 undergoes a pinch effect. At the outlet section 12, the air flow 10 undergoes an expansion accentuated by the fact that, at the outlet 5 of the nozzle 2, the air flow 4 <<sucks in>> the air flow 10 in the vicinity of the outlet section 12, thereby creating a depression so that the downstream pressure in the vicinity of the outlet section 12 is lower than the atmospheric pressure. Thus, the air flow 4 at the outlet 5 of the nozzle 2 is depressurized when passing through the outlet 5 of the nozzle 2 and thereby penetrates the atmosphere more easily. This configuration allows reducing the energy consumption by the turbojet engine, and limiting the pumping risks of the turbojet engine.

When each of the inflatable boxes 6a, 6b, 6c is deformed under the effect of the air flow 10, the ratio of the inlet section 11 to the outlet section 12 of each inflatable box 6a, 6b, 6c or pinch ratio varies, thereby varying the pinch effect caused by the converging 9a area 9 of each inflatable box 6a, 6b, 6c.

The internal pressure of each inflatable box 6a, 6b, 6c is substantially identical and adjustable under the effect of a compressed air motor (not represented) comprised in the device 3 for regulating the pressure of an air flow 4 at the outlet 5 of the nozzle 2. Thus, the deformation that the inflatable boxes 6a, 6b, 6c undergo is adjustable since the inflatable boxes 6a, 6b, 6c have a <<rigidity>> which varies depending on their internal pressure and consequently a different deformation response depending on the internal pressure and on the effect of the air flow 10. In this specific case, the compressed air motor (not represented) and the air flow 10 acts as means 8 for adjusting the position of the inflatable boxes with respect to the nozzle 2.

Referring to FIG. 4, a nozzle 2 comprises a device 3 for regulating the pressure of an air flow 4 at the outlet 5 of the nozzle 2 as is disclosed in FIGS. 2a and 2b and the description associated therein, the device 3 comprising herein in addition to the form of FIGS. 2a and 2b, an air injection means 13 which allows regulating the air flow 10 that enters the converging 9a area 9 according to the form of FIGS. 2a and 2b.

This air injection means 13 comprises a compressed air motor (not represented) and an orifice for ejecting compressed air in the converging 9a area 9. Once injected, said compressed air has an influence variable depending on the pressure at which it is injected in the converging 9a area 9 on the characteristics of the air flow 10.

An air injection means 13 is disposed upstream of each rigid flap 6a, 6b, 6c in the vicinity of the inlet section 11 of said rigid flaps 6a, 6b, 6c thereby enabling an adjustment from the upstream of the air flow 10.

Referring to FIG. 5, a nozzle 2 comprises a device 3 for regulating the pressure of an air flow 4 at the outlet 5 of the nozzle 2 as is disclosed in FIGS. 1a and 1b, the annular element 6 presenting dimensions such that the inlet section 11 of the converging portion of the converging 9a—diverging 9b area 9 presents a surface area with a value close to or larger than that of the outlet section 5 of the nozzle 2.

In this specific case, the jet pump effect is used to increase thrust at takeoff. In cruising flight, the annular element 6 may be displaced thanks to the means 8 in order to lessen this effect and return to substantially the same operation line of the nacelle 1 without annular element 6.

It goes without saying that the present disclosure is not limited to the forms described above as examples but it comprises all technical equivalents and variants of the described means as well as their possible combinations.

What is claimed is:

1. A secondary stream outlet nozzle of a bypass turbojet engine comprising a device for regulating pressure of an air flow at an outlet of the nozzle, said device comprising:
an annular element surrounding the downstream end of the nozzle and at a distance therefrom; and
means for adjusting a position of at least one portion of the annular element with respect to the downstream end of the nozzle,
wherein the annular element forms, together with the downstream end of the nozzle, a pinch area, a most flared portion of which is located upstream of a narrowest portion thereof, and a profile of which varies depending on a position of the annular element.

2. The nozzle according to claim 1, wherein an inner wall of the annular element forms, together with the nozzle, converging and diverging areas facing a direction of the air flow.

3. The nozzle according to claim 2, wherein a borderline between the converging and diverging areas of the annular element is located in a plane in which the downstream end of the nozzle lies, or in at least one of positions of the annular element.

4. The nozzle according to claim 1, wherein the annular element is constituted by a plurality of rigid flaps.

5. The nozzle according to claim 4, wherein the annular element is rotatably movable about axes (Δ′) tangent to the nozzle and substantially orthogonal to the axis (Δ) of the nozzle.

6. The nozzle according to claim 1, wherein the annular element is movable in translation.

7. The nozzle according to claim 1, wherein the annular element comprises inflatable boxes.

8. The nozzle according to claim 7, wherein an internal pressure of the inflatable boxes is regulated by means of a compressed air motor type device.

9. The nozzle according to claim 1, wherein an inlet section in the pinch area presents a surface area which is close to or larger than an outlet section of the nozzle.

10. The nozzle according to claim 1, wherein the nozzle comprises a device configured to inject a modular pressurized air located at the nozzle.

11. A nacelle equipped with the nozzle according to claim 1.
